(19) United States
(12) Patent Application Publication
(10) Pub. No.: US 2004/0089177 A1
(43) Pub. Date: May 13, 2004

(54) Printer of an offset printing machine with separable frame modules

(76) Inventor: Jurgen Alfred Stiel, Thungen (DE)

Correspondence Address: Douglas R Hanscom, Jones Tullar & Cooper, Eads Station, PO Box 2266, Arlington, VA, 22202, US

(21) Appl. No.: 10/312,598

(22) PCT Filed: Mar. 30, 2001
(86) PCT No.: PCT/DE01/01214

(30) Foreign Application Priority Data
Jul. 22, 2000 (DE) 100 35 784.9

(51) Int. Cl. B41F 7/02

(52) U.S. Cl. 101/218

(57) ABSTRACT

The invention relates to a printer comprising multiple printing groups (01-04;06-09), which is mounted in the frame of an offset printing machine. The printing groups are each equipped with at least one printing cylinder (11), at least one transfer cylinder (12) and at least one inking system (13), two of these printing groups being arranged opposite each other. At least one counter-pressure cylinder (16-19) is located between said opposite printing groups. This counter-pressure cylinder can interact with at least one transfer cylinder for printing a line of material. The frame has at least three separable frame modules (21-23). The printing cylinder, transfer cylinder and inking system of at least one left printing group (5) are located in a left frame module (21), while the printing cylinder, transfer cylinder and inking system of at least one right printing group are located in a right frame module (23), with at least one counter-pressure cylinder being located in a middle frame module (22).

The invention relates to a print unit of an offset printing press in accordance with the preamble of claims 1 or 13.

An offset printing press with two print units which are placed opposite each other is known from DE 198 33 468 A1. There, the print units each have two forme cylinders, two transfer cylinders and a counter-pressure cylinder. The print units which are placed opposite each other are here seated in a frame consisting of two frame modules, so that by separating the frame modules the print units can be arranged so their distance in relation to each other can be changed.

A web-fed rotary printing press is known from EP 0 958 917 A1, whose printing group consists of two print units which are arranged opposite each other, so that the paper web to be imprinted can be conducted in a vertical center plane between the print units. Each of the individual print units has a forme cylinder, a transfer cylinder and an ink unit, wherein the paper web is conducted between the transfer cylinders, arranged opposite each other, of two print units which are arranged opposite each other in such a way that the respectively other transfer cylinder operates in the manner of a counter-pressure cylinder. The individual printing groups arranged on top of each other and consisting of two print units each are seated in a frame in such a way that they can be displaced in the vertical direction so that their distance can be changed.

A multi-color web-fed rotary printing press is known from DE 44 29 891 A1, whose print units each have a forme cylinder and a transfer cylinder. In this case the transfer cylinder has twice the circumference of the forme cylinder. Respectively two print units are arranged opposite each other in a frame having three frame modules, wherein the frame modules can be arranged so their distance from each other can be changed in such a way that the area between the individual forme cylinders and the oppositely located transfer cylinder is accessible to the operators.

EP 0 563 007 A1 and U.S. Pat. No. 2,557,381 disclose how to arrange different cylinders in several separable frame modules.

DE-PS M 219 15XII./15d shows a printing group wherein the forme and transfer cylinders have identical diameters, and the counter-pressure cylinder has twice the diameter.

A web-fed offset printing press is known from EP 0 352 521 A2, whose print units have a forme cylinder, a transfer cylinder and a common satellite cylinder, which operates in the manner of a counter-pressure cylinder. There, the circumference of the satellite cylinder corresponds to the circumference of the forme cylinder and to half the circumference of the transfer cylinder.

An offset printing group is known from DE 198 03 809 A1, whose print units have a forme cylinder, a transfer cylinder and a satellite cylinder, which is assigned to two transfer cylinders. There, the circumference of the transfer cylinder is twice the circumference of the forme cylinder, and the circumference of the satellite cylinder corresponds to the circumference of the transfer cylinder.

The object of the invention is based on providing a print unit for an offset printing press.

In accordance with the invention, this object is attained by means of the characteristics of claims 1 or 13.

The advantages to be gained by means of the invention consist in particular in that the frame for the seating the cylinders of the offset printing press in a manner fixed on the frame is composed of three separable frame modules, wherein the forme cylinders, transfer cylinders and ink units and—to the extent provided—other installations, for example dampening units, of the left print units are seated in a left frame module. A right frame module correspondingly receives the forme cylinders, transfer cylinders and ink units of the right print units. A center frame module is provided between the left and right frame modules, in which the counter-pressure cylinders which act together with the transfer cylinders when the web of material, for example a paper web, is imprinted, are seated. In other words this means that, by separating and moving the individual frame modules away from each other, the print units can be opened in such a way that the oppositely located counter-pressure cylinders on the center frame module, as well as the forme and transfer cylinders on the right or left frame module, are simultaneously accessible.

For moving the frame modules away from each other, the frame modules can either be displaced in a direction extending radially in respect to the axes of rotation of the cylinders, and/or in an axis-parallel direction in respect to the axes of rotation of the cylinders.

A further advantage to be gained by means of the invention consists in particular in that the circumference of the counter-pressure cylinder corresponds to 1.5 times or twice the circumference of the transfer cylinder. Furthermore, the circumference of the counter-pressure cylinder must at the same time correspond to a whole number multiple of the height of a printed page in the circumferential direction of the forme cylinder. As a result of this, extraordinarily rigid counter-pressure cylinders are created, which do not exceed the permissible deformation tolerances even under the highest stress. Moreover, a good support effect in respect to the other cylinders of the print units is achieved.

Selecting the circumference of the counter-pressure cylinder to correspond to 1.5 times or twice the circumference of the transfer cylinder is particularly advantageous if, in the course of imprinting a web of material, a counter-pressure cylinder cooperates in the manner of a satellite cylinder with respectively two transfer cylinders, arranged on top of each other, of two print units. Thus, particularly compact structures result from the circumference ratios when installing the cylinders in the frame of an offset printing press.

If the circumference of the forme cylinder substantially corresponds to the height of a printed page, in particular a newspaper page, i.e. if one printed side can be imprinted during one revolution of the forme cylinder, it is particularly advantageous for the support of the forme cylinder to select a transfer cylinder with twice the circumference of the forme cylinder. Because of this the forme cylinder is supported by the substantially more rigid transfer cylinder in an advantageous manner. In accordance with a preferred embodiment of the invention, with this circumferential ratio between the forme cylinder and the transfer cylinder the circumference of the counter-pressure cylinder can be designed to be 1.5 times the circumference of the transfer cylinder. With this constellation the result is that the circumference of the counter-pressure cylinder substantially corresponds to three times, i.e. a whole number multiple, of the height of the printed page.

In accordance with a further embodiment of the invention the circumference of the forme cylinder substantially corresponds to twice the height of a printed page, so that two printed pages can be printed during one revolution of the forme cylinder. With this embodiment the circumference of the transfer cylinder is selected to correspond to the circumference of the forme cylinder, and the circumference of the counter-pressure cylinder again corresponds to 1.5 times the circumference of the transfer cylinder. With this constellation of the cylinder circumferences the result also is that the circumference of the counter-pressure cylinder substantially corresponds to three times, i.e. a whole number multiple, of the height of a printed page.

In accordance with a further embodiment, the circumference of the forme cylinder substantially corresponds to the height of a printed page, and the circumference of the transfer cylinder is selected to correspond to the circumference of the forme cylinder. To achieve advantageous relationships between the cylinder circumferences, the circumference of the counter-pressure cylinder is selected in this embodiment to be twice the circumference of the transfer cylinder. This results in that the circumference of the counter-pressure cylinder substantially corresponds to twice, i.e. to a whole number multiple, the height of a printed page.

An exemplary embodiment of the invention is represented in the drawings and will be described in greater detail in what follows.

Shown are in:

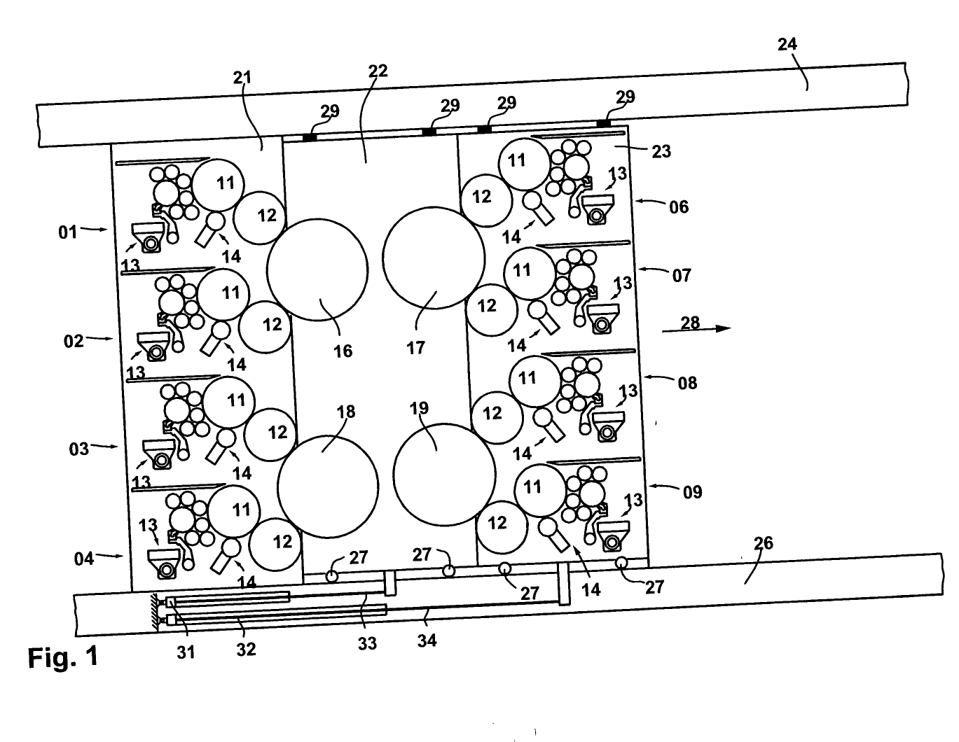

FIG. 1, a lateral cross section of an offset printing press with eight printing groups in a locked frame,

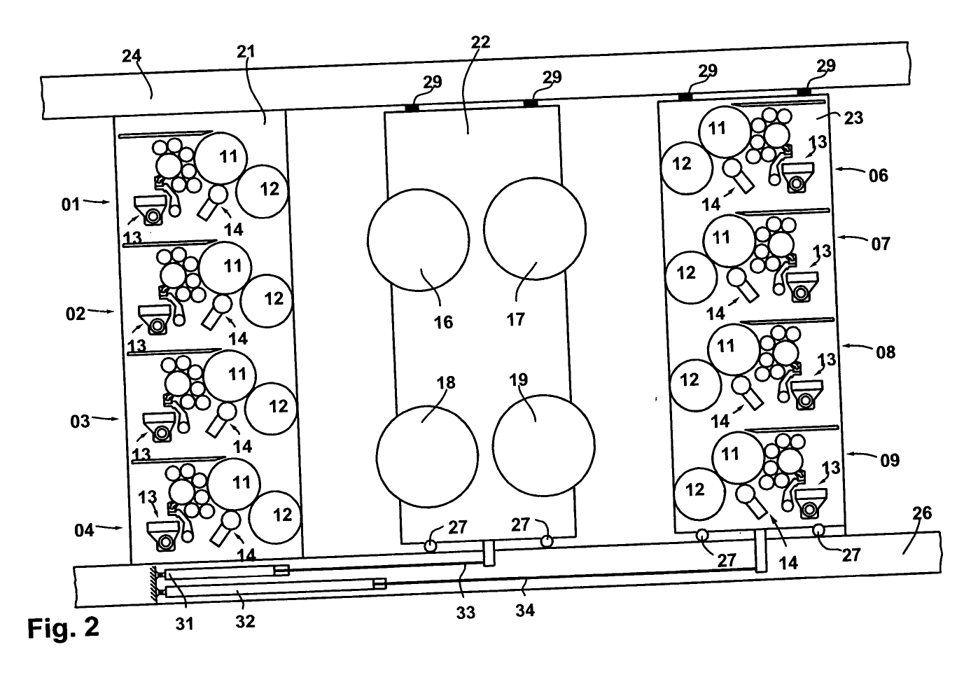

FIG. 2, a lateral cross section of the offset printing press in FIG. 1 with the frame modules moved apart.

An offset printing press, or a section of an offset printing press has, for example, a print unit 01 to 04, 06 to 09, for example eight printing groups 01 to 04, 06 to 09. Each one of the printing groups 01 to 04, 06 to 09 has a forme cylinder 11, a transfer cylinder 12, an ink system 13, in particular an anilox short ink system 13, and a dampening unit 14. Respectively two printing groups 01, 06, 02, 07, 03, 08, 04, 09 are arranged opposite each other in the frame of the offset printing press. In the course of imprinting a web of material, for example a paper web, respectively one counter-pressure cylinder 16 to 19 cooperates with two transfer cylinders 12 of two printing groups 01, 02, 03, 04, 06, 07, 08, 09, which are arranged underneath each other. The frame for seating the cylinders of the printing groups 01 to 04, 06, to 09 is composed of three separable frame modules 21 to 23. Each one of the frame modules 21 to 23 has two lateral elements, in each of which an end of the cylinders of the printing groups 01 to 04, 06 to 09 is seated. The forme cylinders 11 and transfer cylinders 12 of the left printing groups 01 to 04 are seated in the left frame module 21, and the forme cylinders 11 and transfer cylinders 12 of the left printing groups 06 to 09 in the right frame module 23. The counter-pressure cylinders 16 to 19, which act in the manner of satellite cylinders, are seated in the center frame module 22.

In the operating state, only schematically indicated in FIG. 1, the sides of the frame modules 21 to 23 come to rest against each other wherein, for the exact alignment of the relative position of the frame modules 21 to 23 in respect to each other, it is possible, for example, to provide centering pins and centering bores, not represented, in the contact faces which can be brought to rest against each other. After closing the frame by moving the frame modules 21 to 23 against each other, the frame modules 21 to 23 can be connected with each other by locking devices, not represented, for example motor-driven locking spindles, so that the frame modules 21 to 23 cannot be displaced in relation to each other during the operation of the offset printing press.

A frame 24, 26, constructed from transverse supports 24, 26, for example, can be provided for seating the frame modules 21 to 23 in the offset printing press, for example, between which the frame modules 21 to 23 are seated in a load-transferring manner. In the embodiment represented, the left frame module 21, which is connected, fixed to the frame and therefore fixed in place, with the transverse supports 24, 26, is used as the reference point for the frame of the offset printing press. Each of the frame modules 22, 23 is seated by means of rollers 27 on rails, not represented in FIG. 1, provided at the lower transverse support 26, so that they can be arranged in a manner where their distance in relation to the left frame module 21 can be changed. Guide pins 29, which come into engagement with guide grooves arranged on the transverse support 24, are provided for guiding the frame modules 22, 23 when they are being displaced in a direction radially in respect to the axis of rotation of the cylinder 11, 12, as indicated by the movement arrow 28.

Two drive mechanisms 31, 32, which are embodied in the manner of hydraulic cylinders 31, 32, are provided on the lower transverse support 26. By extending, or retracting the piston rods 33, 34 of the drive mechanisms 31, 32, the displaceably seated frame modules 22, 23 can be displaced in the direction of the movement arrow 28, i.e. in a radial direction in respect to the axis of rotation of the cylinder 11, 12, or in the opposite direction.

FIG. 2 represents the frame modules 21 to 23 in the unlocked and moved-apart state. By moving the frame modules 21 to 23 apart, the printing groups 01 to 04, 06 to 09 can be made accessible in a way in which the forme cylinder 11 and the transfer cylinders 12 on the one hand, as well as the counter-pressure cylinders 16 to 19 on the other hand, can be reached in a simple way by the operators. In this case it is conceivable, alternatively or additionally to the lockable arrangement of the frame modules 22, 23 represented in FIGS. 1 and 2, to seat at least two of the frame modules 21 to 23 so they are displaceable in an axis-parallel direction in respect to the axes of rotation of the cylinders 11, 12. For the printing groups 01 to 04, 06 to 09 represented in FIGS. 1 and 2 this would mean that the frame modules 22, 23 would be seated so they could be displaced out of the drawing plane, or into the drawing plane.

The circumference of the forme cylinders 11 has been selected to be such that it substantially corresponds to twice the height of a printed page. This means that two printed pages are transferred to the transfer cylinders 12 during one revolution of the form cylinders 11. To this end it is possible, for example, to fasten each of two printing plates on one-half the circumference of the forme cylinders 11, or alternatively to this, to employ a printing plate on which two printed pages are provided. The circumference of the transfer cylinders 12 corresponds to the circumference of the forme cylinders 11, so that the transfer cylinders 12 perform a rotating movement synchronously in respect to the movement of the forme cylinders 11. The circumference of the counter-pressure cylinders 16 to 19 corresponds to 1.5 times the circumference of the forme cylinders 11, or of the circumference of the transfer cylinders 12. The result of this is that in the course of each full revolution of the counter-pressure cylinders 16 to 19 three printed pages are transferred by the transfer cylinder 12 to the paper web to be imprinted. Particularly advantageous installation conditions result from the selection of the circumferential ratio of 1.5 between the circumference of the transfer cylinder 12 and the circumference of the counter-pressure cylinder 16 to 19, in particular in connection with offset printing presses with transfer cylinders 12 which are arranged on top of each other and cooperate with a counter-pressure cylinder 16 to 19 acting in the manner of a satellite cylinder.

List of Reference Numerals

01 Print unit, printing group, left

02 Print unit, printing group, left

03 Print unit, printing group, left

04 Print unit, printing group, left

05 -

06 Print unit, printing group, right

07 Print unit, printing group, right

08 Print unit, printing group, right

09 Print unit, printing group, right

10 -

11 Forme cylinder

12 Transfer cylinder

13 Ink unit, anilox short ink unit

14 Dampening unit

15 -

16 Counter-pressure cylinder

17 Counter-pressure cylinder

18 Counter-pressure cylinder

19 Counter-pressure cylinder

20 -

21 Frame module, left

22 Frame module, center

23 Frame module, right

24 Transverse support, upper, frame

25 -

26 Transverse support, lower, frame

27 Roller

28 Movement arrow

29 Guide pin

30 -

31 Drive mechanism, hydraulic cylinder

32 Drive mechanism, hydraulic cylinder

33 Piston rod

34 Piston rod

1. A print unit (01 to 04, 06 to 09) of an offset printing press, having respectively at least one forme cylinder (11), at least one transfer cylinder (12) and at least one ink unit (13), wherein two printing groups (01, 06, 02, 07, 03, 08, 04, 09) are arranged opposite each other, and wherein at least one counter-pressure cylinder (16 to 19) is arranged between the oppositely located printing groups (01, 06, 02, 07, 03, 08, 04, 09), characterized in that the print unit (01 to 04, 06 to 09) has at least three separable frame modules (21 to 23), wherein forme cylinders (11), transfer cylinders (12) of at least one left printing group (01 to 04) are arranged in a left frame module (21), forme cylinders (11), transfer cylinders (12) of at least one right printing group (06 to 09) are arranged in a right frame module (23), and in a center module (22) at least one counter-pressure cylinder (16 to 19).

2. The print unit (01 to 04, 06 to 09) in accordance with claim 1, characterized in that an ink unit (13) each is arranged in the left frame module (21) and the right frame module (23).

3. The print unit (01 to 04, 06 to 09) in accordance with claim 1, characterized in that the frame modules (21 to 23) are arranged so their distance from each other can be changed.

4. The print unit (01 to 04, 06 to 09) in accordance with claim 3, characterized in that the arrangement of the frame modules (21 to 23) in relation to each other can be changed in a direction radially in respect to the axes of rotation of the cylinders (11, 12, 16 to 19).

5. The print unit (01 to 04, 06 to 09) in accordance with claim 1, characterized in that the arrangement of the frame modules (21 to 23) in relation to each other can be changed in an axis-parallel direction of the axes of rotation of the cylinders (11, 12, 16 to 19).

6. The print unit (01 to 04, 06 to 09) in accordance with one of claims 1 to 5, characterized in that one of the frame modules (21) is arranged fixed in place, and the other two frame modules (22, 23) are seated so they can be displaced relative thereto.

7. The print unit (01 to 04, 06 to 09) in accordance with claim 6, characterized in that the center frame module (22) is arranged fixed in place.

8. The print unit (01 to 04, 06 to 09) in accordance with claim 6, characterized in that the left or right frame modules (21, 23) are arranged fixed in place.

9. The print unit (01 to 04, 06 to 09) in accordance with one of claims 1 to 8, characterized in that the three frame modules (21, to 23) are arranged so that in the operational state they can be locked.

10. The print unit (01 to 04, 06 to 09) in accordance with one of claims 1 to 9, characterized in that the displaceable frame modules (22, 23) are seated on rollers (27) in a frame (26).

11. The print unit (01 to 04, 06 to 09) in accordance with one of claims 1 to 10, characterized in that the displaceable frame modules (22, 23) can be displaced by remote control by means of a drive mechanism (31, 32).

12. The print unit (01 to 04, 06 to 09) in accordance with one of claims 1 to 11, characterized in that at least one further pair of oppositely located printing groups (01, 06, 02, 07, 03, 08, 04, 09) is arranged above and/or below the oppositely located printing groups (01, 06, 02, 07, 03, 08, 04, 09).

13. A print unit (01 to 04, 06 to 09) of an offset printing press, having at least one forme cylinder (11), at least one transfer cylinder (12), at least one ink unit (13), and a counter-pressure cylinder (16 to 19), characterized in that the circumference of the counter-pressure cylinder (16 to 19) corresponds to 1.5 times or twice the circumference of the transfer cylinder (12), and substantially to a whole number multiple of the height of a printed page in the circumferential direction of the forme cylinder (11).

14. The print unit (01 to 04, 06 to 09) in accordance with claim 13, characterized in that the circumference of the forme cylinder (11) substantially corresponds to the height of a printed page, the circumference of the transfer cylinder (12) to twice the circumference of the forme cylinder (11), and the circumference of the counter-pressure cylinder (16 to 19) to 1.5 times the circumference of the transfer cylinder (12).

15. The print unit (01 to 04, 06 to 09) in accordance with claim 13, characterized in that the circumference of the forme cylinder (11) substantially corresponds to twice the height of a printed page, the circumference of the transfer cylinder (12) to the circumference of the forme cylinder (11), and the circumference of the counter-pressure cylinder (16 to 19) to 1.5 times the circumference of the transfer cylinder (12).

16. The print unit (01 to 04, 06 to 09) in accordance with claim 13, characterized in that the circumference of the forme cylinder (11) substantially corresponds to the height of a printed page, the circumference of the transfer cylinder (12) to the circumference of the forme cylinder (11), and the circumference of the counter-pressure cylinder (16 to 19) to twice the circumference of the transfer cylinder (12).

17. The print unit (01 to 04, 06 to 09) in accordance with one of claims 1 to 16, characterized in that the counter-pressure cylinder (16 to 19) is embodied in the manner of a satellite cylinder, which can cooperate with at least two transfer cylinders (12) when the web of material is imprinted.

18. The print unit (01 to 04, 06 to 09) in accordance with claim 17, characterized in that when the web of material is imprinted, the counter-pressure cylinder (16 to 19) can cooperate with two transfer cylinders (12) arranged one below the other.

19. The print unit (01 to 04, 06 to 09) in accordance with one of claims 1 to 18, characterized in that the ink unit (13) of at least one printing group (01 to 04, 06 to 09) is embodied as a conventional ink unit (13).

20. The print unit (01 to 04, 06 to 09) in accordance with one of claims 1 to 18, characterized in that the ink unit (13) of at least one printing group (01 to 04, 06 to 09) is embodied as an anilox short ink unit (13).

21. The print unit (01 to 04, 06 to 09) in accordance with one of claims 1 to 20, characterized in that a dampening unit (14) is assigned to at least one printing group (01 to 04, 06 to 09).

22. The print unit (01 to 04, 06 to 09) in accordance with one of claims 1 to 21, characterized in that the forme cylinder (11) of at least one printing group (01 to 04, 06 to 09) is arranged so it can be separately switched off together with its ink unit (13) and/or dampening unit (14).

23. The print unit (01 to 04, 06 to 09) in accordance with one of claims 1 to 22, characterized in that at least one printing group (01 to 04, 06 to 09) has a structural height which lies between twice and four times of a diameter of a forme cylinder (11).

24. The print unit (01 to 04, 06 to 09) in accordance with one of claims 1 to 22, characterized in that the drive mechanism of each cylinder (11, 12, 16 to 19) in at least one printing group (01 to 04, 06 to 09) is embodied as an individual drive mechanism.
